(19) United States
(12) Patent Application Publication
(10) Pub. No.: US 2025/0216599 A1
(43) Pub. Date: Jul. 3, 2025

(54) PHOTONIC INTEGRATED CIRCUITS WITH SUBSTRATE NOISE COUPLING MITIGATION

(71) Applicant: Apple Inc., Cupertino, CA (US)

(72) Inventors: Zhechao Wang, San Jose, CA (US); Milad Gholipour Vazimali, Santa Clara, CA (US); Qing Liu, Mountain View, CA (US)

(21) Appl. No.: 18/959,341

(22) Filed: Nov. 25, 2024

Related U.S. Application Data
(60) Provisional application No. 63/615,610, filed on Dec. 28, 2023.

(51) Int. Cl. G02B 6/12; G02B 6/42

(52) U.S. Cl. CPC G02B 6/12002; G02B 6/4238; G02B 6/4245; G02B 6/4277; G02B 6/4283; G02B 2006/12061; G02B 2006/121

(57) ABSTRACT

Embodiments are directed to photonic integrated circuits that include a photonic die having a set of layers supported by a substrate and defining a cavity that extends through the set of layers. The photonic integrated circuits further include an electronic component connected to a bottom wall of the cavity, which may position one or portions of the electronic component in close proximity to the substrate. To mitigate substrate noise coupling between the electronic component and the substrate, a reference component and an electrically insulating layer are positioned between the substrate and the electronic component. The reference component may be electrically connected to an electrical reference plane (e.g., ground or another fixed reference voltage), which may act to shield the electronic component from the substrate and vice versa.

### CROSS-REFERENCE TO RELATED APPLICATIONS

This application is a nonprovisional and claims the benefit under 35 U.S.C. §119(e) of U.S. Provisional Patent Application No. 63/615,610, filed Dec. 28, 2023, the contents of which are incorporated herein by reference as if fully disclosed herein.

### FIELD

This disclosure relates generally to photonic integrated circuits that provide shielding between a substrate of a photonic die and an electronic component associated with the photonic die.

### BACKGROUND

Photonic integrated circuits are becoming increasingly complicated and may integrate a variety of different components into a photonic die. Specifically, photonic integrated circuits may incorporate multiple electronic components into a single photonic die. In these instances, substrate noise coupling may occur as electrical noise from one electronic component couples to another electronic component via the substrate of the photonic die. Substrate noise coupling may be disruptive to the normal operation of a photonic integrated circuit, and thus it may be desirable to minimize this substrate noise coupling.

### SUMMARY

Embodiments described herein are directed to photonic integrated circuits that incorporate a reference component that is configured to mitigate substrate noise coupling. Some embodiments are directed to a photonic integrated circuit that include photonic integrated circuit with a first photonic die that includes a substrate, a cladding layer supported by the substrate, a waveguide layer supported by the cladding layer. The first photonic die defines a cavity that extends through the waveguide layer and the cladding layer. The photonic integrated circuit includes a reference electrical contact layer positioned on a bottom wall of the cavity, an electrically insulating layer positioned on the reference electrical contact layer, and a cavity electrical contact layer positioned on the insulating layer.

The reference electrical contact layer may be electrically connected to a reference plane. The photonic integrated circuit may include an electronic component positioned at least partially inside of the cavity, wherein the cavity electrical contact layer is electrically connected to the electronic component. In some of these variations the electronic component is a second photonic die. The electronic component may be bonded to the cavity electrical contact layer using one or more solder bumps.

In some variations, a portion of the reference electrical contact layer extends outside of the cavity. Additionally or alternatively, a portion of the cavity electrical contact layer may extend outside of the cavity. In some variations, the cavity electrical contact layer is a first cavity electrical contact layer, and the photonic integrated circuit includes a second cavity electrical contact layer positioned at least partially inside of the cavity. In some of these variations, the second cavity electrical contact layer is positioned on the electrically insulating layer. In others of these variations, the reference electrical contact layer is a first reference electrical contact layer, the electrically insulating layer is a first electrically insulating layer, and the photonic integrated circuit include a second reference electrical contact layer positioned on the bottom wall of the cavity and a second electrically insulating layer positioned on the second reference electrical contact layer. The second cavity electrical contact layer may be positioned on the second electrically insulating layer.

Other embodiments are directed to a system that includes a first photonic die and a second photonic die. The first photonic die includes substrate, a cladding layer supported by the substrate, and a waveguide layer supported by the cladding layer, wherein the first photonic die defines a cavity that extends through the waveguide layer and the cladding layer. The second photonic die defines a first laser and includes a first laser electrical contact layer. The system further includes a reference electrical contact layer positioned on a bottom wall of the cavity and an electrically insulating layer positioned on the reference electrical contact layer, such that the second photonic die extends at least partially into the cavity and the reference electrical contact layer and the insulating layer connect the second photonic die to the bottom wall of the cavity. The reference electrical contact layer may be electrically connected to a reference plane.

In some variation, the system includes a laser driver electrically connected to the first laser electrical contact layer. In some of these variations, the system includes a first set of cavity electrical contact layers positioned on the electrically insulating layer, wherein the first set of cavity electrical contact layers electrically connect the laser driver to the first laser electrical contact layer. In some of these variations, the system includes one or more solder bumps connecting the first set of cavity electrical contact layers to the first laser electrical contact layer. In some variations, the system includes a second set of cavity electrical contact layers, wherein the second photonic die comprises a second laser electrical contact layer electrically connected to the second set of cavity electrical contact layers. In some of these instances, the second set of cavity electrical contact layers is positioned on the electrically insulating layer.

Still other embodiments are directed to a photonic integrated circuit that includes a first photonic die having a substrate, a cladding layer supported by the substrate, and a waveguide layer supported by the cladding layer. The first photonic die defines a cavity that extends through the waveguide layer and the cladding layer, and the substrate comprises a doped region that forms a portion of a bottom wall of the cavity. The photonic integrated circuit further includes an electrically insulating layer positioned on the doped region, and a cavity electrical contact layer positioned on the insulating layer. The doped region of the substrate may be electrically connected to a reference plane. In some variations, the photonic integrated circuit includes a second photonic die that extends at least partially into the cavity.

In addition to the example aspects and embodiments described above, further aspects and embodiments will become apparent by reference to the drawings and by study of the following description.

### BRIEF DESCRIPTION OF THE DRAWINGS

The disclosure will be readily understood by the following detailed description in conjunction with the accompanying drawings, wherein like reference numerals designate like structural elements, and in which:

FIGS. 1A and 1B depict top and cross-sectional side views, respectively, of a photonic integrated circuit that includes a first photonic die, where the first photonic die defines a cavity extending at least partially therethrough. FIGS. 1C and 1D show top and cross-sectional views, respectively, of a variation of the photonic integrated circuit of FIGS. 1A and 1B in which the photonic integrated circuit further includes a second photonic die bonded to the first photonic die.

FIG. 2A depicts a top view and FIGS. 2B and 2C depict cross-sectional side views of a photonic integrated circuit, as described herein, that includes a reference electrical contact layer positioned in a cavity of a first photonic die. FIG. 2D depicts a cross-sectional view of a variation of the photonic integrated circuit of FIG. 2A.

FIG. 3 depicts a top view of a variation of a photonic integrated circuit that includes a reference electrical contact layer, where the reference electrical contact layer extends partially outside of a cavity defined in a photonic die.

FIGS. 4A and 4B depict top views of variations of photonic integrated circuits that include multiple shielded cavity electrical contact layers.

FIG. 5 shows a cross-sectional side view of a variation of a photonic integrated circuit as described herein that includes a reference conductive region formed in a substrate of a photonic die.

The use of cross-hatching or shading in the accompanying figures is generally provided to clarify the boundaries between adjacent elements and also to facilitate legibility of the figures. Accordingly, neither the presence nor the absence of cross-hatching or shading conveys or indicates any preference or requirement for particular materials, material properties, element proportions, element dimensions, commonalities of similarly illustrated elements, or any other characteristic, attribute, or property for any element illustrated in the accompanying figures.

It should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The following disclosure relates to photonic integrated circuits that include a photonic die having a set of layers supported by a substrate and defining a cavity that extends through the set of layers. The photonic integrated circuits further include an electronic component connected to a bottom wall of the cavity, which may position one or portions of the electronic component in close proximity to the substrate. As used herein, an “electronic component” may include any device that is capable of receiving and/or transmitting electronic signals, and may in some instances be an active optical device or optoelectronic device.

To mitigate substrate noise coupling between the electronic component and the substrate, a reference component and an electrically insulating layer are positioned between the substrate and the electronic component. The reference component may be electrically connected to an electrical reference plane (e.g., ground or another fixed reference voltage), which may act to shield the electronic component from the substrate and vice versa. In some instances, the reference component is an electrical contact layer that is positioned on a bottom wall of the cavity. In other instances, the reference component is a doped region of the substrate the forms a portion of a bottom wall of the cavity.

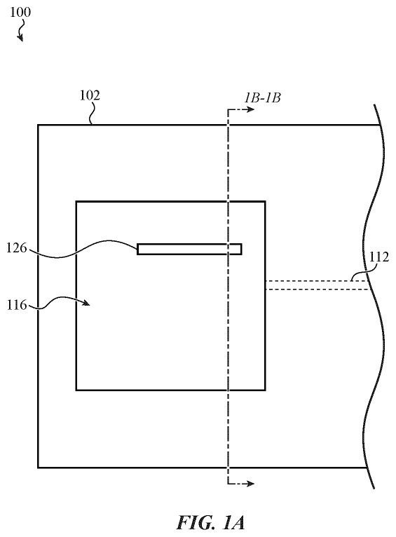

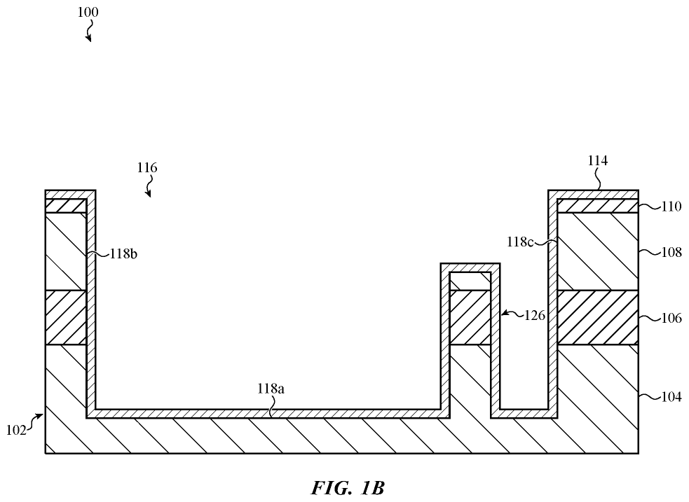

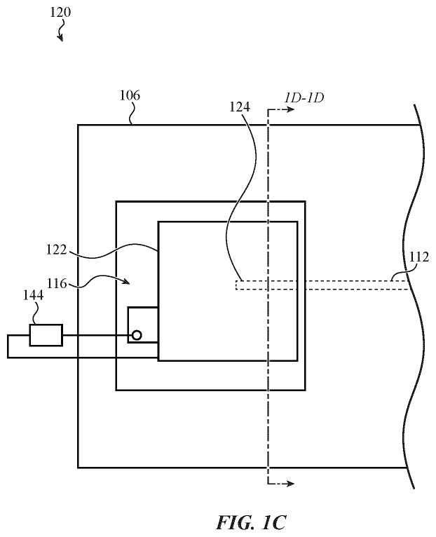

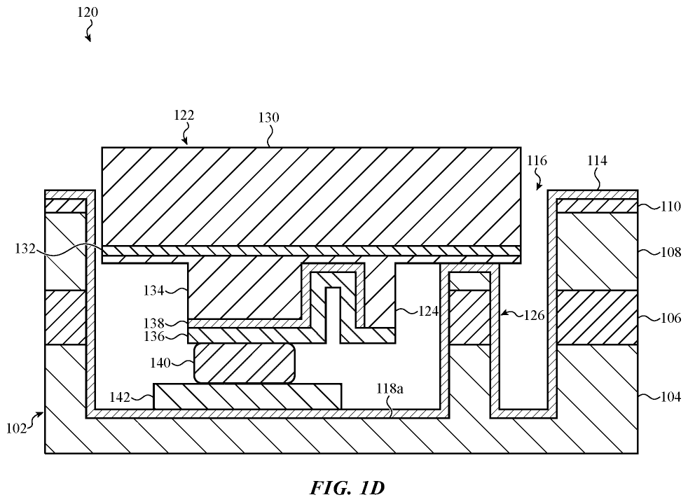

These and other embodiments are discussed below with reference to FIGS. 1A-5. However, those skilled in the art will readily appreciate that the detailed description given herein with respect to these Figures is for explanatory purposes only and should not be construed as limiting.

A photonic integrated circuit may incorporate various optical and electrical components to help facilitate routing, modifying, and/or otherwise manipulating light carried by the photonic integrated circuit. Typically, the various components of a photonic integrated circuit are integrated into a photonic die, which may include a set of layers supported on a substrate. For example, FIG. 1A shows a top view and FIG. 1B shows a cross-sectional side view (taken along line 1B-1B) of a photonic integrated circuit 100 that includes a first photonic die 102. The first photonic die 102 may include a substrate 104 and a set of layers supported by the substrate 104. The set of layers includes a first cladding layer 106 and a waveguide layer 108 positioned on the first cladding layer 106, such that the first cladding layer 106 is positioned between the waveguide layer 108 and the substrate 104.

The waveguide layer 108 may be patterned or otherwise formed to define one or more optical components that carry light through the waveguide layer 108, such as one or more waveguides, splitters, couplers, or the like. The first cladding layer 106 may provide optical confinement to light travelling through the waveguide layer 108 (e.g., to light traveling through a first waveguide 112 defined in the waveguide layer 108). In some instances, one or more additional surfaces of the waveguide layer 108 may be covered with a second cladding layer 110, which may also provide optical confinement to light traveling through the waveguide layer 108.

The various layers of the first photonic die 102 may be formed from any suitable materials depending on the wavelength or wavelengths of light that will be carried by the waveguide layer 108. For example, in some variations, the first photonic die 102 is configured to carry one or more wavelengths of infrared light. In some of these variations, the waveguide layer 108 is formed from silicon, silicon nitride, silica, or the like, the first and second cladding layers 106, 110 are formed from one or more dielectric materials such as silicon dioxide, and the substrate 104 is formed from silicon. In some of these instances, the first photonic die 102 may be manufactured using silicon-on-insulator technology.

In some instances, one or more surfaces of the first photonic die 102 may be covered by a set of dielectric layers. In some instances, the set of dielectric layers may be configured as an anti-reflective coating, which may act to reduce reflections as light passes through the set of dielectric layers. This may help to reduce reflections as light enters or exits the first photonic die 102, such as through a facet of the waveguide layer 108. For example, the first photonic die 102 is shown in FIG. 1B as having an anti-reflective coating 114 deposited on or more surfaces of the first photonic die 102. It should be appreciated that the anti-reflective coating 114 may be formed as a single dielectric layer (e.g., single-layer quarter-wave coating) or as a plurality of dielectric layers (e.g., multi-layer coating).

In some instances, to facilitate incorporation of additional components into the photonic integrated circuit 100, the first photonic die 102 is shaped to define a cavity 116 that extends at least partially through the first photonic die 102. In some instances, such as shown in FIG. 1B, the cavity 116 extends through each of the second cladding layer 110, the waveguide layer 108, and the first cladding layer 106, such that the cavity 116 extends to the substrate 104. In this way, the substrate 104 at least partially defines the cavity 116. Specifically, the cavity 116 may include a bottom wall 118a and a set of sidewalls. The number of sidewalls may depend on the shape of the cavity, and may include, for example, a first sidewall 118b and a second sidewall 118c as shown in FIG. 1B. The substrate 104 forms the bottom wall 118a of the cavity, and the first cladding layer 106 and the waveguide layer 108 may each at least partially form the set of sidewalls. In variations where the first photonic die 102 includes a second cladding layer 110, such as shown in FIG. 1B, the second cladding layer 110 may also at least partially form the set of sidewalls. In some variations, the substrate 104 may at least partially define the set of sidewalls. For example, in some instances the cavity may be shaped such that it extends partially through the substrate 104. In these instances, the substrate 104 may also form a corresponding portion of the set of sidewalls.

One or more components of the photonic integrated circuit 100 may be positioned at least inside the cavity 116 to help position these components relative to the first photonic die 102. In some instances, a component may be positioned against the bottom wall 118a of the cavity 116. When an electronic component is positioned in such a manner, it may be possible for electronic noise to couple between the electronic component and the substrate 104. To the extent that other electronic components are also positioned in sufficiently close proximity to the substrate 104 to allow for electronic noise to couple therebetween (which may not require that these other electronic components are also positioned in the cavity 116), electronic noise may be injected from one electronic component to another via the substrate 104. This substrate noise coupling may negatively impact aspects of the operation of the photonic integrated circuit 100.

For example, FIG. 1C shows a top view and FIG. 1D shows a cross-sectional side view (taken along line 1C-1C) of a variation of a photonic integrated circuit 120 that includes the first photonic die 102 of FIGS. 1A and 1B, as well as a second photonic die 122 that is connected to the first photonic die 102. In this variation, the second photonic die 122 may be configured as a laser die that is operable to generate light, and the first photonic die 102 may be configured to receive light generated by the second photonic die 122. The second photonic die 122 may be bonded to the first photonic die 102 such that a portion of the second photonic die 122 is positioned inside of the cavity 116 defined in the first photonic die 102. For example, the second photonic die 122 may be bonded to the first photonic die 102 in a flip-chip arrangement. With a portion of the second photonic die 122 positioned in the cavity 116, the second photonic die 122 may be bonded to the first photonic die 102 to connect the dies to each other.

It may be desirable to provide for a particular relative orientation between the first photonic die 102 and the second photonic die 122, such as to provide for precise relative placement and alignment between components of these dies. In the example of the photonic integrated circuit 120 shown in FIGS. 1C and 1D, the second photonic die 122 includes a waveguide (referred to herein as “second waveguide 124”). When the second photonic die 122 is bonded to the first photonic die 102, the first waveguide 112 and second waveguide 124 may be positioned relative to each other to allow for light to couple between the waveguides. Accordingly, it may be desirable to introduce mechanical structures configured to provide mechanical alignment between the first photonic die 102 and the second photonic die 122.

In some instances, a standoff structure (e.g., a post) may assist with vertical alignment of the dies. For example, in the variations shown in FIGS. 1A-1D, the first photonic die 102 may include one or more posts (such as post 126) positioned in the cavity 116. For example, portions of the layers of the first photonic die 102 may be removed (e.g., via etching) to define the cavity 116, and this material may be selectively removed to leave the one or more posts. Additionally or alternatively, one or more posts may be separately formed and placed into the cavity 116. As the second photonic die 122 is flipped and inserted into the cavity 116, the one or more posts (such as post 126) may limit how far the second photonic die 122 can extend into the cavity 116, and thereby set the vertical positioning (e.g., the Z-axis positioning) of the second photonic die 122 in the cavity 116.

The second photonic die 122 includes an epitaxial structure 130 that includes various epitaxially-grown layers (such as quantum wells 132), which may be formed from one or more semiconductor materials (e.g., III-V semiconductor materials or the like) that may form one or more laser diodes in the second photonic die 122. Each laser diode may be operable to generate light that may be emitted from the second photonic die 122. For example, the second waveguide 124 may form a laser waveguide (e.g., the second waveguide 124) as part of a first laser of the second photonic die 122. The second waveguide 124 may confine and direct light generated by the second photonic die 122. Light may be emitted from the second photonic die 122 via the second waveguide 124 and may couple into the first photonic die 102 via the first waveguide 112.

To facilitate operation of the second photonic die 122, such as controlling one or more lasers of the second photonic die 122, it may be necessary to route electrical signals (e.g., control signals, power signals, or the like) to and/or from the second photonic die 122. Accordingly, the second photonic die 122 may include one or more electrical contacts that may be used to electrically connect the second photonic die 122 to another portion of the photonic integrated circuit 120 (or to a portion of a larger optical system the includes the photonic integrated circuit 120). Specifically, the second photonic die 122 may be electrically connected to one or more components that can generate and/or receive electrical signals (also referred to herein as “signal devices”), such that electrical signals may be passed between the second photonic die 122 and these signal devices. A signal device may be any circuitry that is capable of generating and/or measuring an electrical signal. For example, a signal device may be a power supply, a controller, a processor, a drive circuit such as a laser driver, or the like.

Accordingly, the number and arrangement of electrical contacts may depend on the design and configuration of the second photonic die 122, as well as the signal device or components to which the second photonic die 122 will be electrically connected. For example, the second photonic die 122 may be electrically connected to a laser driver that is configured to control operation of one or more lasers formed by the second photonic die 122 (e.g., to control the lasers to generate light, adjust a wavelength of light being generated by a laser, or the like). Additionally or alternatively, the second photonic die 122 may include one or more heaters which may act to control the temperature of one or more portions of the second photonic die 122, and the second photonic die 122 is electrically connected to a signal device that is configured to control the heaters. Additionally or alternatively, the second photonic die 122 may include one or more temperature sensors, and the second photonic die 122 is electrically connected to a signal device that is capable of receiving signals from the one or more temperature sensors (e.g., signals that are indicative of temperature(s) measured by the one or more temperature sensors). Additionally or alternatively, the second photonic die 122 may include one or more photodetectors that are configured to measure light. These are just a few examples, and it should be appreciated that a wide variety of electronic components may be incorporated into the cavity 116 of the first photonic die 102 and may be associated with a wide variety of signal devices to facilitate transmission of electrical signals. Additionally, electrical contacts may be formed as part of an electronic component in any suitable manner. For example, the second photonic die 122 may include one or more doped semiconductor regions that act as electrical contacts. Additionally or alternatively, the second photonic die 122 may include one or more electrical contact layers formed from an electrically conductive material such as those described herein.

As one non-limiting example, the second photonic die 122 may include a ridge 134 that may facilitate an electrical connection between the second photonic die 122 and the first photonic die 102. Specifically, the ridge 134 may support an electrical contact layer (referred to herein as “laser electrical contact layer 136”) formed from an electrically conductive material (e.g., gold, copper, aluminum, or the like). The laser electrical contact layer 136 may be electrically coupled to a top surface of the second waveguide 124 to allow current to be supplied to the second waveguide 124 to facilitate generating light. The second photonic die 122 may further include an insulating layer 138 between the laser electrical contact layer 136 and other portions of the epitaxial structure 130 (such as a lateral side of the second waveguide 124) to electrically insulate the laser electrical contact layer 136 from other portions of the epitaxial structure 130. It should be appreciated that while a single waveguide (i.e., the second waveguide 124) is shown in FIGS. 1C and 1D, the second photonic die 122 may include multiple waveguides that each form part of a different respective laser diode. In this way the second photonic die 122 may include multiple lasers. The multiple lasers may, depending on the configuration of the second photonic die 122, be controlled together or separately to generate light. Similarly, the second photonic die 122 may include multiple laser electrical contact layers, thereby allowing different portions of the second photonic die 122 to receive electrical signals.

For example, in order to receive power, the laser electrical contact layer 136 may be electrically connected to a laser driver (represented schematically by block 144 in FIG. 1C). While shown in FIG. 1C as being positioned separately from the first photonic die 102, the laser driver 144 may be positioned in any suitable location within the photonic integrated circuit 120 or an optical system incorporating the photonic integrated circuit 120 as may be desired. Because the laser electrical contact layer 136 is positioned inside of the cavity 116 when the second photonic die 122 is flipped and inserted into the cavity 116, it may be difficult to facilitate electrical contact between the laser electrical contact layer 136 and the laser driver 144.

Accordingly, to make an electrical connection to the laser driver 144, the laser electrical contact layer 136 may be electrically connected to a corresponding electrical contact layer (referred to herein as “cavity electrical contact layer 142”) that is formed on, either directly or indirectly, the bottom wall 118a of the cavity 116. For example, a solder bump 140 (which may represent a single solder bump or multiple solder bumps) may electrically connect the laser electrical contact layer 136 to the cavity electrical contact layer 142. The solder bump 140 may be heated during assembly to temporarily melt the solder bump 140. When the solder of the solder bump 140 cools, the solder bump 140 may bond the second photonic die 122 to the first photonic die 102. The solder bump 140 may represent any electrically conductive material that is used to bond two components, including, but not limited to, bumps made from gold, conductive epoxy, copper, or the like.

The electrical connection between the laser electrical contact layer 136 and the cavity electrical contact layer 142 may allow for current to be passed from the laser driver 144 to the second photonic die 122 to help power the first laser of the second photonic die 122. Specifically, current supplied by the laser driver 144 is passed to the laser diode associated with second waveguide 124 and thereby generates light via the second waveguide 124 during operation of the second photonic die 122. In other words, the cavity electrical contact layer 142 electrically connects the laser driver 144 to the laser electrical contact layer 136, such that current passes through cavity electrical contact layer 142 as it passes between the laser driver 144 and the laser electrical contact layer 136.

Because the cavity electrical contact layer 142 is formed on the bottom wall 118a of the cavity 116, the cavity electrical contact layer 142 may be positioned in direct contact or close proximity (e.g., on the order of tens or hundreds of nanometers) to the substrate 104 of the first photonic die 102. In these instances, it may be possible for electronic noise to couple to and/or from the second photonic die 122 and the substrate 104 during operation of the second photonic die 122. Even in instances where an anti-reflective coating 114 is deposited on the bottom wall 118a of the cavity (e.g., between the cavity electrical contact layer 142 and the substrate 104), electronic noise may still capacitively couple between the cavity electrical contact layer 142 and the substrate 104.

To help reduce substrate noise coupling between a substrate of a photonic die and an electronic component at least partially positioned in a cavity of the photonic die, variations of the photonic integrated circuits described herein incorporate a reference electrical contact layer that is configured to electrically shield one or more cavity electrical contact layers from the substrate. While the various examples described herein utilize a photonic die as an example of an electronic component, it should be appreciated that the principles described herein may utilized to reduce substrate noise coupling with any suitable electronic component that is incorporated into a photonic integrated circuit as described herein. It should also be appreciated that the principles described herein may be utilized to shield the electronic component from noise present in the substrate and/or to shield the substrate from noise generated by the electronic component.

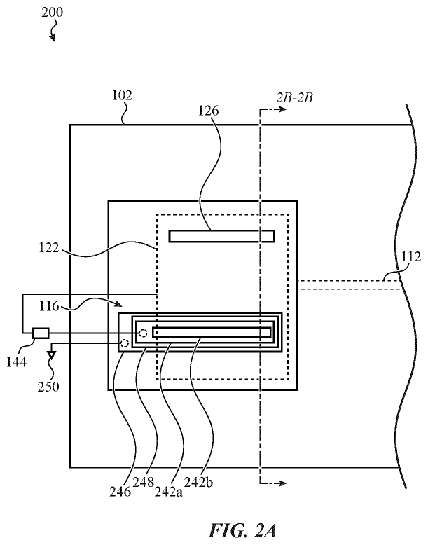

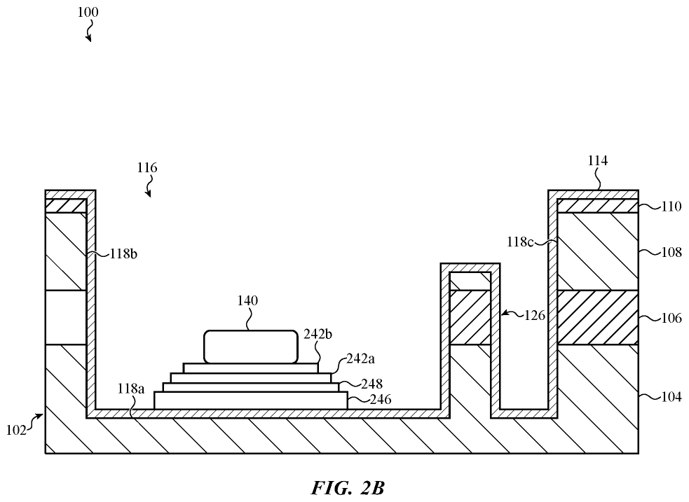

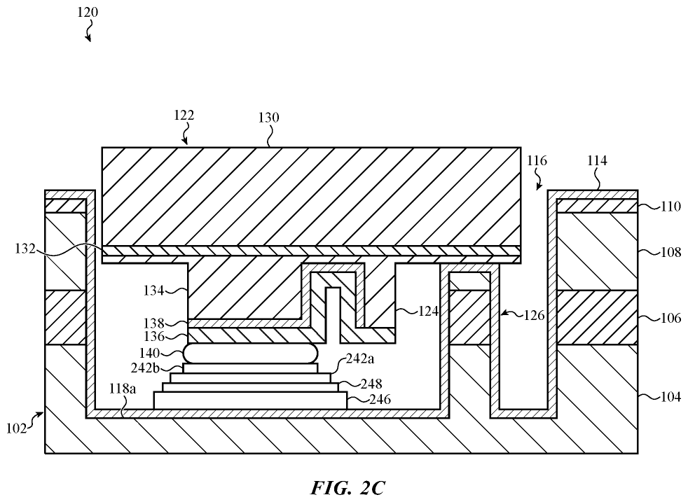

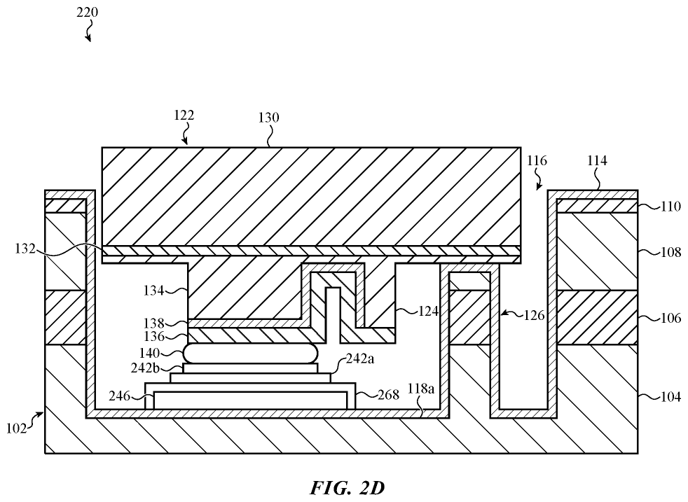

For example, FIG. 2A shows a top view of a variation of a photonic integrated circuit 200 that includes the first photonic die 102 described herein with respect to FIGS. 1A-1D. In this variation, the photonic integrated circuit 200 includes a reference electrical contact layer 246 that is positioned in the cavity 116. The reference electrical contact layer 246 may be used to shield an electronic component that is positioned at least partially in the cavity 116 and is connected to the substrate 104 of the first photonic die 102. For the purpose of illustration, the photonic integrated circuit 200 is depicted as including the second photonic die 122 and the laser driver 144 of FIGS. 1C and 1D. It should be appreciated, however, that the principles described herein may be applied to other electronic components that are positioned at least partially in the cavity 116 and that include one or more electrical contacts that are electrically connected to one or more signal devices.

For ease of illustration, the second photonic die 122 is shown in FIG. 2A in phantom. FIG. 2B shows a cross-sectional side view (taken along line 2B-2B) of the photonic integrated circuit 200 without the second photonic die 122. FIG. 2C shows a cross-sectional side view (taken along line 2B-2B) of the photonic integrated circuit 200 with the second photonic die 122 bonded to the bottom wall 118a of the cavity 116.

As shown in FIGS. 2A-2B, the photonic integrated circuit 200 includes a reference electrical contact layer 246 positioned on the bottom wall 118a of the cavity 116. In some variations, the reference electrical contact layer 246 may directly contact the substrate 104 of the first photonic die 102. In other variations, one or more additional layers may be positioned between substrate 104 and the reference electrical contact layer 246. For example, in some variations the photonic integrated circuit 200 may include an anti-reflective coating 114, such as described in more detail with respect to FIGS. 1A-1D, that is deposited on a bottom wall 118a of the cavity 116. In some of these instances, the anti-reflective coating 114 may be positioned between the reference electrical contact layer 246 and the substrate 104 such that the reference electrical contact layer 246 indirectly contacts the bottom wall 118a of the cavity 116.

The reference electrical contact layer 246 may be positioned between the electronic component and the bottom wall 118a of the cavity 116, which thereby allows the reference electrical contact layer 246 to provide shielding (e.g., against substrate noise coupling) between the substrate 104 and the electronic component. The reference electrical contact layer 246 may be formed from an electrically conductive material, such as an electrically conductive metal (e.g., gold, copper, aluminum, or the like). The reference electrical contact layer 246 may be electrically connected to an electrical reference plane 250, such that the reference electrical contact layer 246 is held at a fixed voltage during operation of the photonic integrated circuit 200. This fixed voltage may be a circuit ground for the photonic integrated circuit 200 or another fixed voltage. By holding the reference electrical contact layer 246 at a fixed voltage, the reference electrical contact layer 246 may shield the electronic component from electronic noise carried by the substrate and/or shield the substrate from electronic noise generated by the electronic component.

The photonic integrated circuit 200 further includes an electrically insulating layer 248 that is positioned on the reference electrical contact layer 246. In some variations the electrically insulating layer 248 is positioned in direct contact with the reference electrical contact layer 246. The electrically insulating layer 248 may be formed from an electrically insulating material (e.g., silicon dioxide or the like), and may act to electrically isolate the reference electrical contact layer 246 from other electrically conductive portions of the photonic integrated circuit 200. For example, the photonic integrated circuit 200 may further include a set of cavity electrical contact layers 242a-242b positioned on the electrically insulating layer 248, such that the electrically insulating layer 248 separates and electrically isolates the reference electrical contact layer 246 from the set of cavity electrical contact layers 242a-242b.

The set of cavity electrical contact layers 242a-242b may be a single layer (e.g., such as the cavity electrical contact layer 142 depicted in FIGS. 1C-1D) or may include multiple layers, each of which may be formed from a corresponding electrically conductive material such as described herein (e.g., gold, copper, aluminum or the like). For example, in the variation shown in FIGS. 2A-2C the set of cavity electrical contact layers 242a-242b includes a first cavity electrical contact layer 242a and a second cavity electrical contact layer 242b positioned on the first cavity electrical contact layer 242a. The set of cavity electrical contact layers 242a-242b may electrically connect an electronic component (e.g., the second photonic die 122) to a signal device (e.g., the laser driver 144), such as described in more detail with respect to FIGS. 1C and 1D. In some of these instances, the photonic integrated circuit 200 includes a solder bump 140 that is used to bond and electrically connect the set of cavity electrical contact layers 242a-242b to the electronic component. For example, in instances where the electronic component includes the second photonic die 122, the solder bump 140 may bond and electrically connect the set of cavity electrical contact layers 242a-242b to the laser electrical contact layer 136. In these instances, the second cavity electrical contact layer 242b may help control the positioning of the solder when the second photonic die 122 is bonded to the first photonic die 102. Specifically, as the solder bump 140 is melted during assembly, some of the solder may flow from its original position. Surface tension at the edges of the of the second cavity electrical contact layer 242b may reduce the likelihood that solder from the solder bump 140 overflows from the second cavity electrical contact layer 242b. In instances where solder does unintentionally flow over the edge of the second cavity electrical contact layer 242b, the edges of the first cavity electrical contact layer 242a may act to further constrain the solder. Accordingly, to route an electronic signal between the second photonic die 122 and the laser driver 144, current passes through the set of cavity electrical contact layers 242a-242b and the solder bump 140 to reach the laser electrical contact layer 136 may pass.

When assembled, such as shown in FIG. 2C, the second photonic die 122 may be physically connected to the first photonic die 102 via at least the reference electrical contact layer 246, the electrically insulating layer 248, and the set of cavity electrical contact layers 242a-242b. For example, in instances where the photonic integrated circuit 200 includes a solder bump 140, an electrical contact of the second photonic die (e.g., the laser electrical contact layer 136 in the variation shown in FIG. 2C) is bonded to and thereby electrically connected to the set of cavity electrical contact layers 242a-242b via the solder bump 140. In this way, the set of cavity electrical contact layers 242a-242b may electrically connect the laser electrical contact layer 136 to the laser driver 144, and may physically connect the laser electrical contact layer 136 to the bottom wall 118a of the cavity 116 (e.g., via electrically insulating layer 248 and the reference electrical contact layer 246).

During operation of the photonic integrated circuit 200, the reference electrical contact layer 246 may be electrically connected to the electrical reference plane 250 during operation of the optical component. In this way, electronic signals may be passed through the set of cavity electrical contact layers 242a-242b (e.g., between the second photonic die 122 and the laser driver 144 as depicted in FIG. 2A), and the reference electrical contact layer 246 will provide shielding between the cavity electrical contact layers 242a-242b and the substrate 104.

In the variation shown in FIGS. 2A-2C, the electrically insulating layer 248 is positioned completely above the reference electrical contact layer 246. In these instances, the electrically insulating layer 248 is positioned only on a top surface of the reference electrical contact layer 246. In other variations, the electrically insulating layer 248 may be configured such that it covers at least a portion of one or more side surface of the electrical contact layer 246. For example, FIG. 2D shows a cross-sectional side view of another variation of a photonic integrated circuit 220, which is configured the same as the photonic integrated circuit 200 of FIGS. 2A-2C, except that the electrically insulating layer 248 has been replaced by electrically insulating layer 268. In these instances, the electrically insulating layer 268 is positioned to at least partially cover a top surface of the reference electrical contact layer 246, and is further positioned to at least partially cover one or more side surfaces of the reference electrical contact layer 246. In this way, one or more portions of the electrically insulating layer 268 are coplanar with the reference electrical contact layer 246. This may help to reduce the area of the reference electrical contact layer 246 that is exposed within the cavity 116, which may thereby reduce the risk that an inadvertent electrical connection is made between the reference electrical contact layer 246 and the set of cavity electrical contact layers 242a-242b. It should be appreciated that a portion of the reference electrical contact layer 246 may remain uncovered by the electrically insulating layer 268 to facilitate electrically connecting the reference electrical contact layer 246 to the reference plane 250.

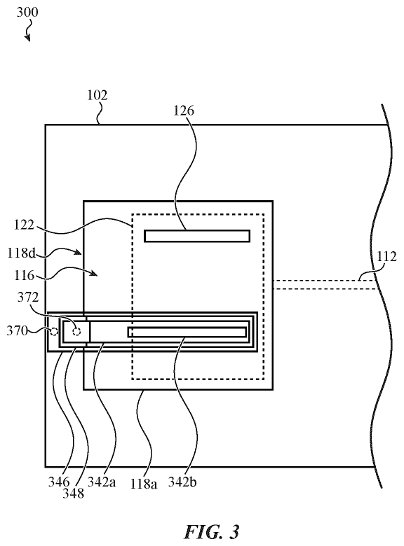

In the variations of the photonic integrated circuits 200, 220 shown in FIGS. 2A-2D, the reference electrical contact layer 246 and the set of cavity electrical contact layers 242a-242b are positioned entirely within the cavity 116. To make an electrical connection between these electrical contact layers and other components (e.g., between the reference electrical contact layer 246 and the reference plane 250), it may be necessary to place wirebonds or additional electrical traces inside of the cavity 116 to provide these electrical connections. In other variations, some or all of the reference electrical contact layer 246 and/or the set of cavity electrical contact layers 242a-242b may be configured to extend outside of the cavity 116, which may provide additional flexibility for making electrical connections to these components. For example, FIG. 3 shows a top view of a photonic integrated circuit 300 that includes the first photonic die 102 and the second photonic die 122 described herein with respect to FIGS. 1A-1D. The photonic integrated circuit 300 comprises a reference electrical contact layer 346, an electrically insulating layer 348, and a set of cavity electrical contact layers 342a-342b that includes a first cavity electrical contact layer 342a and a second cavity electrical contact layer 342b. These components may be configured the same as the corresponding components of the photonic integrated circuits 200 and 220 of FIGS. 2A-2D, except that the reference electrical contact layer 346, the electrically insulating layer 348, and the first cavity electrical contact layer 346 extend at least partially outside of the cavity 116.

Specifically, a first portion of the reference electrical contact layer 346 may be positioned on the bottom wall 118a of the cavity 116, such as described in more detail herein. A second portion of the reference electrical contact layer 346 may be positioned on a sidewall of the cavity 116 (e.g., a third sidewall 118d of the cavity 116 as shown in FIG. 3), and a third portion of the reference electrical contact layer 346 may be positioned outside of the cavity 116. This may facilitate forming an electrical connection with the reference electrical contact layer 346 outside of the cavity (e.g., at a contact point 370 as shown in FIG. 3). Similarly, the first cavity electrical contact layer 342a may include a first portion positioned on the bottom wall 118a of the cavity 116, a second portion positioned on a sidewall, and a third portion positioned outside of the cavity 116. This may facilitate electrical connections to the first cavity electrical contact layer 342a, such as at contact point 372 shown in FIG. 3. To help maintain electrical isolation between the reference electrical contact layer 346 and the first cavity electrical contact layer 342a, the electrically insulating layer 348 may include a first portion positioned between the respective first portions of the reference electrical contact layer 346 and the first cavity electrical contact layer 342a, a second portion positioned between the respective second portions of the reference electrical contact layer 346 and the first cavity electrical contact layer 342a, and a third portion positioned between the respective third portions of the reference electrical contact layer 346 and the first cavity electrical contact layer 342a.

While both the reference electrical contact layer 346 and the first cavity electrical contact layer 342a are shown in FIG. 3 as being configured to at least partially extend outside of the cavity 116, it should be appreciated that the photonic integrated circuit 300 may alternatively be configured such that only one of the reference electrical contact layer 346 and the first cavity electrical contact layer 342a extend at least partially outside of the cavity 116. While the second cavity electrical contact layer 342b is shown in FIG. 3 as being positioned entirely inside of the cavity 116, it may be similarly configured to extend at least partially outside of the cavity 116 if so desired.

The various photonic integrated circuits described herein with respect to FIGS. 2A-3 discuss providing shielding between the substrate 104 and a single electrical contact of a component positioned at least partially in the cavity 116. In some instances, it may be desirable to provide shielding for multiple electrical contacts within the cavity 116. In some of these instances, multiple different components may be positioned at least partially inside of the cavity 116, each of which includes a corresponding electrical contact. Additionally or alternatively, a single component positioned at least partially inside of the cavity 116 may include multiple electrical contacts. For example, in the variations described herein where the electronic component is a second photonic die 122 that includes one or more lasers, the second photonic die 122 may include multiple electrical contacts (a first laser electrical contract layer, a second laser electrical contact layer, etc.) that are used to control operation of a single laser and/or multiple electrical contacts that are used to control operation of different lasers.

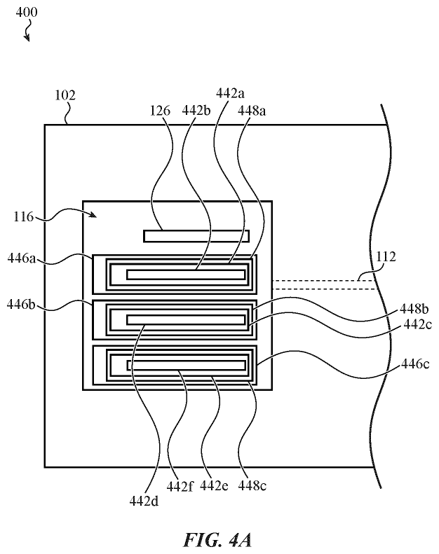

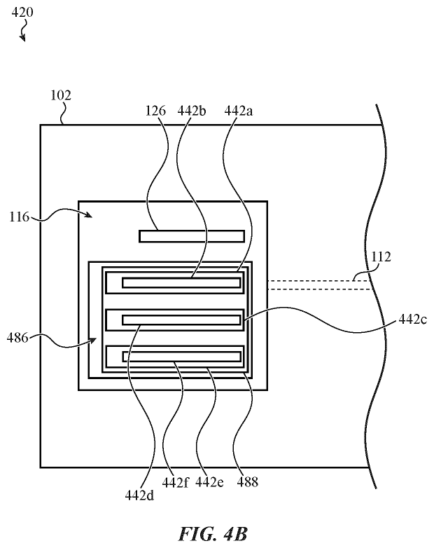

FIG. 4A shows at top view of one variation of a photonic integrated circuit 400 that includers the first photonic die 102 described herein with respect to FIGS. 1A-1D. The photonic integrated circuit 400 further includes a plurality of laterally spaced reference electrical contact layers 446a-446c, a plurality of electrically insulating layers 448a-448c, and a plurality of sets of cavity electrical contact layers 442a-442f. Each reference electrical contact layer is associated with a corresponding electrically insulating layer and set of cavity electrical contact layers, and may be configured in any manner such as described herein with respect to the photonic integrated circuits of FIGS. 2A-3. For example, the photonic integrated circuit 400 includes a first reference electrical contact layer 446a positioned on the bottom wall 118a of the cavity 116, a first electrically insulating layer 448a positioned on the first reference electrical contact layer 446a, and a first set of cavity electrical contact layers 442a-442b positioned on the first electrically insulating layer 448a. The first reference electrical contact layer 446a may be electrically connected to a first reference plane (e.g., reference plane 250). The first set of cavity electrical contact layers 442a-442b may form an electrical connection between a signal device and an electrical contact of a component positioned at least partially in the cavity 116. For example, the first set of cavity electrical contact layers 442a-442b may be electrically connected to a first laser electrical contact layer of a second photonic die (e.g., the second photonic die 122).

Similarly, the photonic integrated circuit 400 includes a second reference electrical contact layer 446b positioned on the bottom wall 118a and laterally spaced from the first reference electrical contact layer 446a. A second electrically insulating layer 448b may be positioned on the second reference electrical contact layer 446b, and a second set of cavity electrical contact layers 442c-442d positioned on the second electrically insulating layer 448b, such that the second electrically insulating layer 448b electrically isolates the second set of cavity electrical contact layers 442c-442d from the second reference electrical contact layer 446b. The second reference electrical contact layer 446b may be electrically connected to a second reference plane, which may be the same as or different from the first reference plane. The second set of cavity electrical contact layers 442c-442d may form an electrical connection between a signal device and an electrical contact of a component positioned at least partially in the cavity 116. In some instances, the second set of cavity electrical contact layers 442c-442d and the first set of cavity electrical contact layers 442a-442b are electrically connected to different electrical contacts of the same component. For example, the second set of cavity electrical contact layers 442c-442d may be electrically connected to a second laser electrical contact layer of a second photonic die (e.g., the second photonic die 122). Alternatively, the second set of cavity electrical contact layers 442c-442d and the first set of cavity electrical contact layers 442a-442b may be connected to electrical contacts of different components. Similarly, the second set of cavity electrical contact layers 442c-442d and the first set of cavity electrical contact layers 442a-442b may be electrically connected to the same signal device or to different signal devices.

It should be appreciated that in these instances, the photonic integrated circuit 400 may include any number of different reference electrical contact layers and sets of cavity electrical contact layers. For example, in the variation shown in FIG. 4A, the photonic integrated circuit 400 includes a third reference electrical contact layer 446c positioned on the bottom wall 118a and laterally spaced from the first and second reference electrical contact layers 446a, 446b, as well as a third electrically insulating layer 448c positioned on the third reference electrical contact layer 446c and a third set of cavity electrical contact layers 442e-442f positioned on the third electrically insulating layer 448c. In these instances, each reference electrical contact layer provides shielding for its respective set of cavity electrical contact layers.

In other variations, multiple sets of cavity electrical contact layers may share a single reference electrical contact layer. For example, FIG. 4B shows another variation of a photonic integrated circuit 420 that is configured the same as the photonic integrated circuit 400 of FIG. 4A except that the plurality of reference electrical contact layers 446a-446c have been replaced with a shared reference electrical contact layer 486, and the plurality of insulating layers 448a-448c have been replaced with a shared electrically insulating layer 488. In these instances, each of the plurality of sets of cavity electrical contact layers (e.g., the first set of cavity electrical contact layers 442a-442b, the second set of cavity electrical contact layers 442c-442d, and the third set of cavity electrical contact layers 442e-442f) are positioned on the shared reference electrical contact layer 486, and are electrically isolated therefrom via the shared electrically insulating layer 488. In this way, the shared reference electrical contact layer 486 may provide shielding to multiple sets of cavity electrical contact layers (and thereby, multiple electrical contacts of one or more components positioned at least partially in the cavity 116). Depending on the size of the shared reference electrical contact layer 486, it may be desirable to provide multiple electrical connections between the shared reference electrical contact layer 486 and the reference plane to reduce potential local voltage fluctuations in the shared reference electrical contact layer 486.

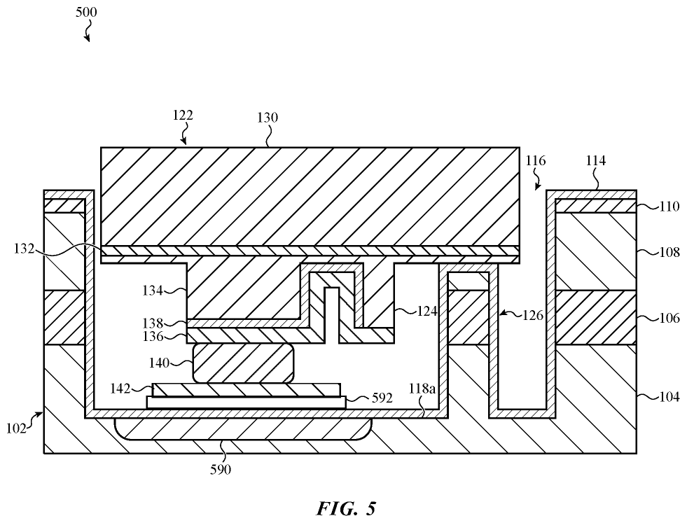

In some variation, in addition to or instead of the reference electrical contact layers described herein with respect to FIGS. 2A-4B, a portion of the substrate 104 may be doped to form a conductive region that has a higher electrical conductivity than surrounding portions of the substrate and that defines a portion of the bottom wall 118a of the cavity 116. For example, FIG. 5 shows a cross-sectional side view of a variation of photonic integrated circuit 500 that is configured the same as the photonic integrated circuit 120 of FIGS. 1C and 1D, except that a portion of the substrate 104 includes a doped region that is doped to define a conductive reference region 590. The conductive reference region 590 may form a portion of the bottom wall 118a of the cavity 116, and a set of cavity electrical contacts (e.g., cavity electrical contact layer 142) may be positioned above the conductive reference region 590. An electrically insulating layer 592 may be positioned between the conductive reference region 590 and the set of cavity electrical contacts to provide electrical isolation. The electrically insulating layer 592 may be directly in contact with the conductive reference region 590 or may be separated therefrom by one or more additional materials, such as an anti-reflective coating 114 as shown in FIG. 5. The conductive reference region 590 may be electrically connected to a reference plane (e.g., reference plane 250), and thus may provide shielding between the set of cavity electrical contacts and the other portions of the substrate 104 surrounding the conductive reference region 590.

For example, the second photonic die 122 described herein with respect to FIGS. 1C and 1D may be bonded to the first photonic die 102 as described in more detail herein. The cavity electrical contact layer 142 may provide an electrical connection between a laser driver (not shown) and the laser electrical contact layer 136, and these elements may be shielded from substrate noise coupling via the conductive reference region 590 of the substrate 104. In some variations, the photonic integrated circuit 500 includes one or more reference electrical contact layers (not shown) which may be configured in any manner as described herein with respect to FIGS. 2A-4B. In some these instances, the reference electrical contact layers may be placed in direct contact with the conductive reference region 590 such that the conductive reference region 590 is electrically connected to the reference electrical contact layers. In some of these variations, the reference electrical contact layers may electrically connect the conductive reference region 590 to a reference plane. Additionally or alternatively, while a single conductive reference region 590 is shown in FIG. 5, it should be appreciated that the photonic integrated circuit 500 may include multiple doped regions that form different corresponding portions of the bottom wall 118a of the cavity 116. In these instances, each doped region may form a different corresponding conductive reference region and may be electrically connected to a corresponding reference plane.

Although the disclosure above is described in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the some embodiments of the invention, whether or not such embodiments are described and whether or not such features are presented as being a part of a described embodiment. Thus, the breadth and scope of the present invention should not be limited by any of the above-described exemplary embodiments but is instead defined by the claims herein presented.

What is claimed is:

1. A photonic integrated circuit, comprising:
a first photonic die comprising:
a substrate;
a cladding layer supported by the substrate; and
a waveguide layer supported by the cladding layer, wherein the first photonic die defines a cavity that extends through the waveguide layer and the cladding layer;
a reference electrical contact layer positioned on a bottom wall of the cavity;
an electrically insulating layer positioned on the reference electrical contact layer; and
a cavity electrical contact layer positioned on the electrically insulating layer.

2. The photonic integrated circuit of claim 1, wherein:
the reference electrical contact layer is electrically connected to a reference plane.

3. The photonic integrated circuit of claim 1, comprising:
an electronic component positioned at least partially inside of the cavity, wherein:
the cavity electrical contact layer is electrically connected to the electronic component.

4. The photonic integrated circuit of claim 3, wherein:
the electronic component is a second photonic die.

5. The photonic integrated circuit of claim 3, wherein:
the electronic component is bonded to the cavity electrical contact layer using one or more solder bumps.

6. The photonic integrated circuit of claim 1, wherein:
a portion of the reference electrical contact layer extends outside of the cavity.

7. The photonic integrated circuit of claim 1, wherein:
a portion of the cavity electrical contact layer extends outside of the cavity.

8. The photonic integrated circuit of claim 1, wherein:
the cavity electrical contact layer is a first cavity electrical contact layer; and
the photonic integrated circuit comprises a second cavity electrical contact layer positioned at least partially inside of the cavity.

9. The photonic integrated circuit of claim 8, wherein:
the second cavity electrical contact layer is positioned on the electrically insulating layer.

10. The photonic integrated circuit of claim 8, wherein:
the reference electrical contact layer is a first reference electrical contact layer;
the electrically insulating layer is a first electrically insulating layer;
the photonic integrated circuit comprises a second reference electrical contact layer positioned on the bottom wall of the cavity and a second electrically insulating layer positioned on the second reference electrical contact layer; and
the second cavity electrical contact layer is positioned on the second electrically insulating layer.

11. A system comprising:
a first photonic die comprising:
a substrate;
a cladding layer supported by the substrate; and
a waveguide layer supported by the cladding layer, wherein the first photonic die defines a cavity that extends through the waveguide layer and the cladding layer;
a second photonic die defining a first laser and comprising a first laser electrical contact layer;
a reference electrical contact layer positioned on a bottom wall of the cavity; and
an electrically insulating layer positioned on the reference electrical contact layer, wherein:
the second photonic die extends at least partially into the cavity; and
the reference electrical contact layer and the electrically insulating layer connect the second photonic die to the bottom wall of the cavity.

12. The system of claim 11, wherein:
the reference electrical contact layer is electrically connected to a reference plane.

13. The system of claim 11, comprising:
a laser driver electrically connected to the first laser electrical contact layer.

14. The system of claim 13, comprising:
a first set of cavity electrical contact layers positioned on the electrically insulating layer, wherein:
the first set of cavity electrical contact layers electrically connect the laser driver to the first laser electrical contact layer.

15. The system of claim 14, comprising:
one or more solder bumps connecting the first set of cavity electrical contact layers to the first laser electrical contact layer.

16. The system of claims 14, comprising:
a second set of cavity electrical contact layers, wherein:
the second photonic die comprises a second laser electrical contact layer electrically connected to the second set of cavity electrical contact layers.

17. The system of claim 16, wherein the second set of cavity electrical contact layers is positioned on the electrically insulating layer.

18. A photonic integrated circuit, comprising:
a first photonic die comprising:
a substrate;
a cladding layer supported by the substrate; and
a waveguide layer supported by the cladding layer, wherein:
the first photonic die defines a cavity that extends through the waveguide layer and the cladding layer; and
the substrate comprises a doped region that forms a portion of a bottom wall of the cavity;
an electrically insulating layer positioned on the doped region; and
a cavity electrical contact layer positioned on the electrically insulating layer.

19. The photonic integrated circuit of claim 18, wherein:
the doped region of the substrate is electrically connected to a reference plane.

20. The photonic integrated circuit of claim 19, comprising:
a second photonic die that extends at least partially into the cavity.
